(19) United States
(12) Patent Application Publication
(10) Pub. No.: US 2013/0316083 A1
(43) Pub. Date: Nov. 28, 2013

(54) MULTIPURPOSE PAINT FORMULATION

(71) Applicants: Maria French, Westlake, OH (US); Glen Joseph Kaszubski, Copley, OH (US)

(72) Inventors: Maria French, Westlake, OH (US); Glen Joseph Kaszubski, Copley, OH (US)

(73) Assignee: AKZO NOBEL COATINGS INTERNATIONAL B.V., ARNHEM (NL)

(21) Appl. No.: 13/885,511

(22) PCT Filed: Nov. 15, 2011
(86) PCT No.: PCT/EP11/70170

§ 371 Date: Aug. 9, 2013

Related U.S. Application Data
(60) Provisional application No. 61/414,195, filed on Nov. 16, 2010.

(51) Int. Cl. C08K 7/20

(52) U.S. Cl. CPC C08K 7/20
USPC 427/372.2; 524/494; 524/500

(57) ABSTRACT

The present invention includes a paint formulation comprising a water-based latex and microspheres, wherein the microspheres have an effective particle size and are present in an effective amount to both provide a smooth paint finish and fill, cover or conceal superficial blemishes in a painted substrate when the paint formulation is dry. In another embodiment, the present invention includes a method of applying a paint formulation to a substrate having superficial surface imperfections comprising applying with a first paint applicator the paint formulation to the superficial imperfections in the surface to be painted, allowing the applied paint formulation to dry until it is at least dry to the touch, applying with a second paint applicator the paint formulation to the surface of the substrate to produce a first paint surface.

### BACKGROUND OF THE INVENTION

1. Field of the Invention The present invention relates to paint formulations and methods of applying paint formulations.

2. Description of Related Art

One impediment to achieving a smooth painted finish is superficial surface imperfections in the substrate to be painted. This is a particular concern for architectural surfaces, such as walls and ceilings. Superficial surface imperfections include without limitation, hairline cracks, nail holes, scratches and other small blemishes. There are known architectural paints that cover or fill superficial surface imperfections. However, these paints leave a textured rather than smooth finish. Further, some known architectural paints that do provide a smooth finish may appear to fill or cover superficial surface imperfections when wet. However, all or a portion of such superficial surface imperfections tend to reappear upon drying. Spackle or such similar filler may be used to patch such superficial surface imperfections prior to painting. However, this can be time consuming and inconvenient.

### SUMMARY OF THE INVENTION

The present invention includes a paint formulation comprising a water-based latex and microspheres, wherein the microspheres have an effective particle size and are present in an effective amount to both provide a smooth paint finish and fill, cover or conceal superficial blemishes in a painted substrate when the paint formulation is dry.

In another embodiment, the present invention includes a method of applying a paint formulation to a substrate having superficial surface imperfections comprising

applying with a first paint applicator the paint formulation to the superficial imperfections in the surface to be painted,

allowing the applied paint formulation to dry until it is at least dry to the touch,

applying with a second paint applicator the paint formulation to the surface of the substrate to produce a first paint surface.

### DESCRIPTION OF THE INVENTION

Paint formulations are disclosed that provide both a smooth finished surface when dry and fill, substantially fill, cover or conceal to a point of aesthetic acceptability to a typical user, superficial surface imperfections in substrates to be painted with broad wall paint. Superficial surface imperfections are typically, for non-limiting example, small blemishes, hairline cracks, scratches and nail holes about 1/16 inch or smaller, such as those used to hang pictures and other decorative items. Though not so limited, substrates to be painted with broad wall paint are typically dry wall, concrete, plaster and masonry.

An additional advantage of the paint formulations disclosed are that they may be used as a primer, frequently making it unnecessary to use a separate primer formulation to achieve the desired finished paint surface. A paint formulation of the current invention may be employed as the primer layer.

Although the paint formulations disclosed remedies superficial surface imperfections without the need for filler, and primer is frequently unnecessary, other typical substrate preparation is still useful, such as without limitation, removing any portion of the substrate that may protrude from the superficial surface imperfection so that the edges of the such surface imperfections are flush with the surface of the substrate.

The paint formulation technology disclosed comprises a water based latex binder and microspheres wherein the microspheres have an effective particle size and are present in an effective amount to both provide a smooth paint finish and fill or conceal superficial blemishes in a painted substrate when the paint formulation is dry. An effective particle size may be between 10 and 200 microns. An effective amount of microspheres may be between 3% and 6% by volume of a white base paint formulation and up to 12% weight by volume of a clear paint formulation. In one embodiment the latex binder has a low Tg. In another embodiment the paint formulation has a Tg of about 8-9° C. & a minimum film formation temperature in the range of about 2 to 11° C.

In one embodiment, the particles comprise microspheres having a particle size between 10 and 200 microns. One embodiment of the microspheres is glass beads or glass bubbles. In other embodiments the glass beads have a particle size distribution between 30 to 115 (with an effective top particle size of 120) and 20 to 80 (with an effective top particle size of 85) available in the K Series of glass bubbles from 3M Energy and Advanced Materials Division, St. Paul, Minn. In other embodiments, the glass beads have a particle size distribution of 30 to 115 (effective top size 120), 30 to 105 microns (effective top particle size of 115 microns), 30 to 90 (effective top size of 105), 25 to 90 (effective top size of 105) and 20 to 80 (effective top size of 85) available, respectively, as K1, K15, k30, K25 and K37 glass bubbles from 3M Energy and Advanced Materials Division, St. Paul, Minn. In another embodiment, the particles are plastic beads, for non-limiting example Aquatex beads 325, 230, 200, and 140, having respectively a maximum particle size of 44, 63, 74, and 105 microns and a mean particle size of 11-15, 36-43, 35-45 and 45-55 microns, available from Micro Powders, Inc., Tarrytown, N.Y. Combinations of different grades and profiles of particles may be used, including without limitation glass bubbles and beads and plastic beads. In one embodiment the glass or plastic beads or bubbles are present up 12% by volume of a clear paint formulation. In a white base, glass or plastic beads or bubbles are present 3 to 6% by volume of the paint formulation.

In another embodiment, one or more rheological additives are present in the paint formulation, for non-limiting example, the combination of Acrysol SCT 275 non-ionic urethane rheological modifier and Aquaflow NHS300 non-ionic high shear rheological modifier, used in volume ratios of 50-80%:20-50% SCT:NHS. Embodiments using rheological additives may be white tint base and intermediate tint base formulas.

In addition to the latex and particles, the paint formulations of the current invention may also comprise other components, including without limitation those typical for latex paint formulations. These other components may include thickeners, surfactants, pigments, fillers deformers, solvents, coalescents, plasticizers, biocides and dispersants.

Other aspects of the current invention are paint application methods.

In one embodiment, a paint formulation is applied to a substrate having superficial surface imperfections by a method comprising
1. Applying with a first paint applicator the paint formulation to the superficial surface imperfections.
2. Allowing the applied paint formulation to dry until it is at least dry to the touch.
3. With a second paint applicator, applying the paint formulation to the surface to be painted to produce a first paint surface.

In another embodiment, the method of applying the paint formulation comprises the following additional steps
4. Allowing the paint first painted surface to dry until it is at least dry to the touch.
5. With a third paint applicator, applying the paint formulation to the first paint surface to produce a second paint surface.

Another method of applying the paint formulation comprises
1. Applying with the first paint applicator paint formulation to the superficial surface imperfections in the surface to be painted.
2. Allowing the applied paint formulation to dry until it is at least dry to the touch.
3. With a second paint applicator, applying a second application of the paint formulation to the dry paint formulation that is at least dry to the touch.
4. Allowing the second application of the paint formulation to dry until it is at least dry to the touch.
5. With a third paint applicator, applying the paint formulation to the surface to be painted to produce a paint surface.

The first, second and third paint applicators may be the same or different. Paint applicators useful in the current invention may include, but are not limited to, paint brushes, paint rollers, foam paint brushes, sponges, palette knives, flat plastic edges, doctor blades, putty knives or spatulas,

paper towel or other flexible semi-absorbent woven or nonwoven material in sheet form,

the corner of a paper towel or other semi-absorbent woven or nonwoven material in sheet form;

the corner of a paper towel or other semi-absorbent woven or nonwoven material in sheet form folded at least once to form at least one corner,

the corner of a paper towel or other semi-absorbent woven or nonwoven material in sheet form folded in half multiple times to form at least one corner,

the corner of a paper towel or other semi-absorbent woven or nonwoven material in sheet form folded in half multiple times to form an approximate square,

the corner of a paper towel or other semi-absorbent woven or nonwoven material in sheet form folded in half four times at to form an approximate square.

In one embodiment of the method of applying the paint formulation, the first paint applicator is a brush and the second and third paint applicators are paint rollers.

In another embodiment, the first and second paint applicators are a brush and the third paint applicator is a roller.

In one embodiment the first paint applicator is the corner of a paper towel.

In another embodiment the first paint applicator is the corner of a paper towel wherein the corner is formed by folding the paper towel in half.

In another embodiment the first paint applicator is the corner of a paper towel where the corner is formed by folding the paper towel multiple times.

In another embodiment the first paint applicator is the corner of a paper towel wherein the corner is formed by folding the paper towel in half multiple times.

In another embodiment the first paint applicator is the corner of a paper towel wherein the corner is formed by folding the paper towel in half multiple times to form an approximate square.

In another embodiment the first paint applicator is the corner of a paper towel, wherein the corner is formed by folding the paper towel in half four times to form an approximate square.

In one embodiment, the first paint applicator is the corner of a paper towel or other material in sheet form, the corner formed or not by one of the folding methods described above. In a further embodiment, the paint application method comprises bringing a corner of the paper towel or other material in sheet form into contact with the paint and applying the paint to superficial surface imperfections on the surface to be painted, including without limitation, hairline cracks, nail holes, scratches and other small blemishes, then removing excess paint. One method of removing the excess paint is to use a clean corner of the paper towel or other material in sheet form.

### EXAMPLE

The following paint formulation was produced according to the instant disclosure:

| | | | |
|---|---|---|---|
| | LBS/100 | | |
| MATERIAL | GALS | GALS | % |

PRE THINDOWN (made on an air motor with a paddle stirrer)

| | | | |
|---|---|---|---|
| ROVACE 9900 EMULSION from Dow | 314.246 | 35.19 | 31.18 |
| GO TO LOW SPEED | | | |
| TIONA 596 SLURRY from Millennium | 270.082 | 13.779 | 26.798 |
| Chemicals | | | |
| WATER, TAP | 21.994 | 2.64 | 2.182 |
| AGITATE FOR 5 MINS, LOW SPEED | | | |
| MIX NEXT ITEM WELL BEFORE USE | | | |
| DREWPLUS T 4507 FOAM from | 0.88 | 0.12 | 0.087 |
| Aqualon | | | |
| WATER, TAP | 8.797 | 1.056 | 0.873 |
| AGITATE FOR 10 MINS, LOW SPEED | | | |

GRIND (made on a Cowles high speed disperser
with impeller blade)

| | | | |
|---|---|---|---|
| WATER, TAP | 47.506 | 5.703 | 4.714 |
| LATTICE NTC-80 from FMC | 1.32 | 0.102 | 0.131 |
| Corporation | | | |
| MIX FOR 15 MINS, HIGH SPEED | | | |
| WATER, TAP | 1.759 | 0.211 | 0.175 |
| NATROSOL PLUS 330 from Aqualon | 0.44 | 0.039 | 0.044 |
| DOWICIL 75 from Dow | 1.1 | 0.085 | 0.109 |
| WATER, TAP | 1.759 | 0.211 | 0.175 |
| MIX NEXT ITEM WELL BEFORE USE | | | |
| DREWPLUS T 4304 FOAM from | 1.759 | 0.238 | 0.175 |
| Aqualon | | | |
| TAMOL 731A DISPERSANT from Dow | 4.399 | 0.478 | 0.436 |
| WATER, TAP | 7.038 | 0.845 | 0.698 |
| TRYCOL 7000 from Cognis | 2.639 | 0.302 | 0.262 |
| AQU D-4341, STRODEX from Aqualon | 2.639 | 0.278 | 0.262 |
| SAFSIL CT450 from CR Minerals | 82.992 | 4.15 | 8.235 |
| Company LLC | | | |
| MINEX 7 from Unimim | 26.392 | 1.216 | 2.619 |
| WATER, TAP | 3.519 | 0.422 | 0.349 |
| DISPERSE FOR 30 MINS, HIGH SPEED | | | |
| WASH MILL | | | |
| WATER, TAP | 35.19 | 4.225 | 3.492 |

Add Grind to Pre thindown while stirring with paddle stirrer on
the air motor and then follow with following thin down process.
THIN DOWN

| | | | |
|---|---|---|---|
| WATER, TAP | 63.617 | 7.637 | 6.312 |
| PREMIX NEXT 3 ITEMS WITH | | | |
| COWLES-TYPE AGITATOR | | | |
| WATER, TAP | 48.386 | 5.809 | 4.801 |
| NATROSOL PLUS 330 from Aqualon | 0.88 | 0.077 | 0.087 |
| WATER, TAP | 1.759 | 0.211 | 0.175 |
| ADD PREMIX IMMEDIATELY | | | |
| WITH HIGH SPEED AGITATION | | | |
| WASH PREMIX TANK WITH NEXT | | | |
| ITEM | | | |
| WATER, TAP | 3.519 | 0.422 | 0.349 |
| AGITATE FOR 25 MINS, HIGH SPEED | | | |
| AMMONIA HYDROXIDE 19 | 0.88 | 0.113 | 0.087 |
| AGITATE FOR 15 MINS, HIGH SPEED | | | |
| AQUAFLOW NHS-300 RHE from | 4.399 | 0.509 | 0.436 |
| Aqualon | | | |
| AGITATE FOR 10 MINS, HIGH SPEED | | | |
| ACRYSOL SCT-275 RHEO from Dow | 9.677 | 1.125 | 0.96 |
| AGITATE FOR 20 MINS, HIGH SPEED | | | |
| DREWPLUS T 4507 FOAM from | 1.759 | 0.24 | 0.175 |
| Aqualon | | | |
| AGITATE FOR 20 MINS, HIGH SPEED | | | |
| POLYPHASE PW40 from Troy Chemical | 1.32 | 0.132 | 0.131 |
| Corp. | | | |
| AGITATE FOR 60. TO 60. MINUTES | | | |
| BEFORE TESTING | | | |
| K15 glass bubbles from 3M Energy and | 35.19 | 12.434 | 3.492 |
| Advanced Materials | | | |
| AGITATE FOR 60. TO 60. MINUTES | | | |
| BEFORE TESTING | | | |
| | 1007.837 | 99.999 | 100.001 |

The produced paint was tested as follows:

Nail Hole Testing

Test #1

1. Nail holes of three different sizes (nail from a. picture hook that can support 50 lbs, nail from a. picture hook that can support 100 lbs and a small finish nail) were made in dry wall.

2. The produced paint formulation was applied with a brush to the nail holes and allowed to dry.

3. The dry wall was painted with a roller with one coat of the paint formulation and allowed to dry.

4. A second coat of paint formulation was applied with a roller and allowed to dry.

5. The resulting nail hole coverage was good for all three sizes of nail hole.

Test #2

Test #1 was repeated except a putty knife was used rather than a brush in step 2. The resulting nail hole coverage was good for all three sizes of nail hole.

Hairline Crack Testing

Test #3

1. A 7 inch by 12 inch dry wall piece was cut in half.

2. The two pieces were rejoined with joining compound and the joining compound was allowed to dry.

3. Primer was applied to the joined panel.

4. The joined panel was cracked to generate a hairline crack.

5. The produced paint formulation was applied with a brush to the hairline crack and allowed to dry.

6. The dry wall was painted with a roller with one coat of the paint formulation and allowed to dry.

7. A second coat of paint formulation was applied with a roller and allowed to dry.

8. The paint formulation successfully covered the hairline crack.

Based on visual observation of the painted dry wall in Tests #1-#3, the produced paint formulation when dry provided a smooth finish comparable to conventional commercial latex paint.

1. A paint formulation comprising a water-based latex and microspheres, wherein the microspheres have an effective particle size and are present in an effective amount to both provide a smooth paint finish and fill, cover or conceal superficial blemishes in a painted substrate when the paint formulation is dry.

2. The paint formulation of claim 1 wherein the microspheres are glass beads.

3. The paint formulation of claim 2 wherein the glass beads have a particle size distribution between 30 to 115 microns with an effective top particle size of 120 microns and 20 to 80 microns with an effective top particle size of 85 micron microns.

4. The paint formulation of claim 2 wherein the glass beads have a particle size distribution of 30 to 105 microns with an effective top particle size of 115 microns.

5. The paint formulation of claim 1 wherein the microspheres are plastic beads.

6. The paint formulation according to claim 1 any of the preceding claims wherein the microspheres comprise up to 12% by volume of the paint formulation.

7. The paint formulation according to claim 1 any of the preceding claims wherein the microspheres comprise 3% to 6% by volume of the paint formulation.

8. A method of applying a paint formulation to a substrate having superficial surface imperfections, comprising:
applying with a first paint applicator the paint formulation to the superficial imperfections in the surface to be painted,
allowing the applied paint formulation to dry until it is at least dry to the touch,
applying with a second paint applicator the paint formulation to the surface of the substrate to produce a first paint surface.

9. The method of applying a paint formulation according to claim 8, further comprising:
allowing the first paint surface to dry until it is at least dry to the touch, and
with a third paint applicator, applying the paint formulation to the first paint surface to produce a second paint surface.

10. The method of applying a paint formulation according to claim 8 wherein the first paint applicator is a flexible semi-absorbent woven or nonwoven material in sheet form.

11. The method of applying a paint formulation according to claim 10 wherein the first paint applicator is a corner of the semi-absorbent woven or nonwoven material in sheet form.

12. The method of applying a paint formulation according to claim 11 wherein the corner is formed by folding at least once the semi-absorbent woven or nonwoven material in sheet form.

13. The method of applying a paint formulation according to claim 12 wherein the corner is formed by folding the semi-absorbent woven or nonwoven material in sheet form in half multiple times.

14. The method of applying a paint formulation according to claim 13 wherein the corner of the semi-absorbent woven or nonwoven material in sheet form is formed by folding the material in sheet form in half multiple times to form an approximate square.

15. The method of applying a paint formulation according to claim 14 wherein the corner of the semi-absorbent woven or nonwoven material in sheet form is formed by folding the material in sheet form in half four times to form an approximate square.

16. The method of applying a paint formulation according to claim 10 wherein the flexible semi-absorbent woven or nonwoven material is a paper towel.

17. The paint formulation according to claim 3 wherein the microspheres comprise up to 12% by volume of the paint formulation.

18. The paint formulation according to claim 3 wherein the microspheres comprise 3% to 6% by volume of the paint formulation.

19. The method of applying a paint formulation according to claim 9 wherein the first paint applicator is a flexible semi-absorbent woven or nonwoven material in sheet form.

20. The method of applying a paint formulation according to claim 15 wherein the flexible semi-absorbent woven or nonwoven material is a paper towel.
